(19) United States
(12) Patent Application Publication
(10) Pub. No.: US 2002/0083137 A1
(43) Pub. Date: Jun. 27, 2002

(54) Collaboration system and workstation

(76) Inventors: Edwin H. Rogers, Ballston Lake, NY (US); Cheryl Geisler, Troy, NY (US); John M. Tobin, Albany, NY (US); James J. Johns, Morris Plains, NJ (US)

Correspondence Address: John W. LaBatt, Hoffman, Warnick & D'Alessandro LLC, Three E-Comm Square, Albany, NY, 12207, US

(21) Appl. No.: 09/998,056

(22) Filed: Nov. 29, 2001

Related U.S. Application Data
(60) Provisional application No. 60/250,726, filed on Dec. 1, 2000.
(60) Provisional application No. 60/250,745, filed on Dec. 1, 2000.

(51) Int. Cl. G06F 15/16; G09G 5/00

(52) U.S. Cl. 709/205; 345/753

(57) ABSTRACT

A system and workstation for collaboration among multiple users are provided. The system includes a public system, a plurality of private systems and a cooperation system. The cooperation system allows users of private systems to individually control the public system. The workstation is configured to hold a plurality of private displays and at least one public display.

### REFERENCE TO PRIOR APPLICATION

The current application claims priority to co-pending provisional applications Serial Nos. 60/250,726 and 60/250,745, both filed on Dec. 1, 2000.

### BACKGROUND OF THE INVENTION

1. Technical Field

The invention generally relates to a collaboration system and workstation. More particularly, the collaboration system provides a public system and a plurality of private systems, whereby a user of a private system can individually control the public system. The workstation is configured to hold a plurality of private displays and at least one public display.

2. Background Art

In business, the need for employees to efficiently collaborate on projects is essential. In particular, many projects often require the involvement of many employees. Traditionally, each employee was assigned a component of the project to complete on his/her own. Communication and information dissemination regarding each employee's component took place electronically, with electronic mail messages or the like circulating between the employees.

Such a system is inferior because each employee largely performs his/her component independently, without collaboration with fellow employees.

Heretofore, various systems have been implemented to provide improved collaboration and communication between employees. Such systems involve multiple employees collaborating simultaneously over a computer network. Each employee has access to the same application program and can individually take control of the program.

One such system is Microsoft's NetMeeting®. This software allows users to share application programs executing in a Microsoft Windows® environment. Specifically, a user can share one or more application programs with a user at another computer system. Each computer sharing the application can view its output and, under certain circumstances, control the application with remote keyboard and pointing device information. However, this system does not allow a remote user to take over complete control of a remote system. A user is only given permission to control a specific set of applications.

Another system is Symantec's PCAnywhere®. This system does not provide for collaboration among numerous users. In particular, the system does not provide for users taking turns controlling a remote system. Also, both NetMeeting® and PCAnywhere® operate only with the Microsoft Windows® operating system and neither provides a workstation facility enabling lines of communication, view and control.

These and other systems provide only limited collaboration, especially when employees are located in different locations, thus, having limited lines of communications and sight with the other employees. Moreover, control is generally limited to individual application programs, as opposed to an entire computer system. This becomes a larger problem when different operating systems (platforms) are utilized or desired. For example, one employee may be using a Windows operating system while another employee is using the Macintosh operating system. Accordingly, the level of collaboration and control is limited.

In addition, previous workstations attempt to allow users to more effectively collaborate on projects. However, these workstations fail to provide each user a line of sight and communication with every other user. In contrast, the workstations typically only provide a user a line of communication and sight with users in close physical proximity (i.e., immediately next to each other). Moreover, the previous workstations fail to provide a way for all users to view their own private displays as well as a public display.

Therefore, there exists a need for a collaboration system and workstation whereby users can individually control a public system, as opposed to specific programs executing on the public system. Moreover, there exists a need for a collaboration system and workstation whereby users can have efficient lines of communication with other users. A need also exists for a collaboration system and workstation that allows for collaboration between users regardless of the platforms being used. A further need exists for a collaboration system configured around a workstation so that each user maintains lines of communication and sight with every other user.

### SUMMARY OF THE INVENTION

The invention overcomes the problems associated with existing systems by providing a collaboration system and workstation that allows for multiple private system users to individually control a public system. Specifically, the invention provides a collaboration system whereby users can view and manipulate their own private system as well as a public system. Further, the invention utilizes a workstation that provides each user a line of communication and a line of sight with every other user.

A first aspect of the invention provides a collaboration system and workstation for a plurality of users, comprising: a public system; a plurality of private systems, wherein each user operates their own private system; a cooperation system for a user of a private system to control the public system; and a workstation including: a public section including at least one public segment, wherein each public segment is configured to hold a public display for the public system; and a plurality of private sections positioned around the public section, wherein each private section is configured to hold a private display for a private system.

A second aspect of the invention provides a collaboration system and workstation for allowing collaboration among a plurality of users, comprising: a collaboration system for a user of a private system to control a public system from the private system, wherein each private system has a private display and the public system has at least one public display; a public section including at least one public segment, wherein each public segment is configured to hold a public display; and a plurality of private sections each positioned adjacent to the public section, wherein each private section is configured to hold a private display.

A third aspect of the invention provides a workstation for allowing collaboration among a plurality of users, comprising: a public section including at least one public segment, wherein each public segment is configured to hold a public display for a public system; and a plurality of private sections positioned around the public section, wherein each private section is configured to hold a private display for a private system.

It is therefore an advantage of the invention to provide a collaboration system and workstation whereby users can individually control a public system while being able to view both their private system as well as the public system. It is a further advantage of the invention to provide such a collaboration system and workstation whereby users can communicate with all other users. It is still a further advantage of the invention to utilize a workstation configured to hold a plurality of private displays and at least one public display.

### BRIEF DESCRIPTION OF THE DRAWINGS

These and other features and advantages of the invention will be more readily understood from the following detailed description of the various aspects of the invention taken in conjunction with the accompanying drawings in which:

FIG. 1 depicts a block diagram of a computer system having a collaboration system in accordance with one embodiment of the invention;

FIG. 2 depicts a more detailed view of a portion of a collaboration system according to one embodiment of the invention;

FIG. 3 shows a detailed view of the data according to one embodiment of the invention;

FIG. 4 depicts a perspective view of a workstation according to one embodiment of the invention; and

FIG. 5 depicts a top view of a workstation according to one embodiment of the invention.

It is noted that the drawings of the invention are not to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements between the drawings.

### DETAILED DESCRIPTION OF THE INVENTION

Generally stated, the invention provides a collaboration system and workstation, the collaboration system comprising a public system, a plurality of private systems and a cooperation system. The cooperation system enables a user of a private system to individually control the entire public system. Specifically, when a user controls the public system, the user can perform any operation, rather than merely controlling certain application programs executing on the public system. Thus, control of the public system is not limited. For example, a user can initiate or terminate application programs, use active applications, alter system parameters, and even shut down the public system, etc. This provides enhanced flexibility in the actions that a user can share among all the users. A private display for each private system and a public display for the public system can be provided so that each user can view both displays.

The workstation can comprise private sections configured around a public section. The workstation provides each user the ability to view and communicate with every other user. Consequently, the collaboration system and workstation allows multiple users to efficiently communicate and collaborate, for example, on a project.

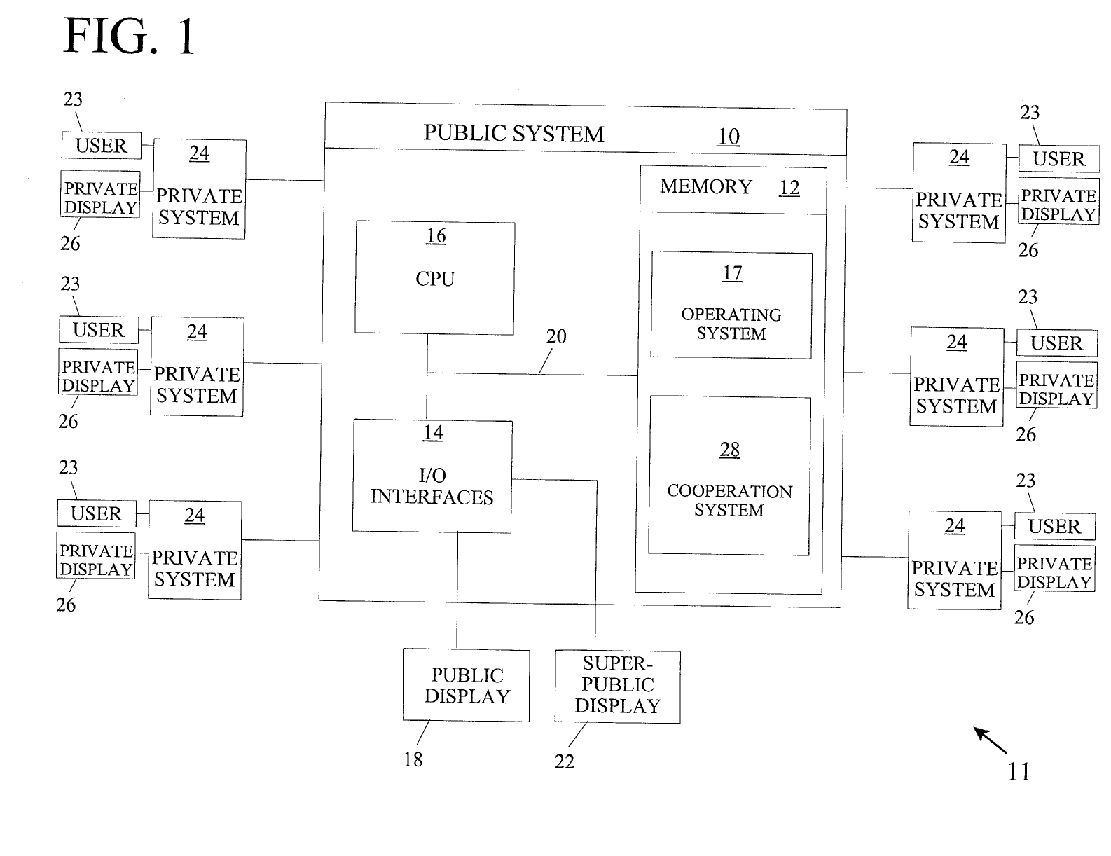

Referring now to FIG. 1, a collaboration system 11 according to one embodiment of the invention is shown. Collaboration system 11 generally comprises public system 10, a plurality of private systems 24 and cooperation system 28. As shown, collaboration system 11 may also include a public display 18 and a super-public display 22 in communication with public system 10. Additionally, each private system 24 can have a private display 26. Users 23 each operate one of the plurality of private systems 24. Collaboration system 11 can be implemented such that each user 23 has a view of their own private display 26, public display 18 and other users 23 (e.g., via a virtual conference) with whom collaboration is desired.

Public system 10 generally comprises memory 12, input/output (I/O) interfaces 14, central processing unit (CPU) 16 and bus 20. CPU 16 may comprise a single processing unit, or be distributed across one or more processing units in one or more locations, e.g., on a client and server. Memory 12 may comprise any known type of data storage and/or transmission media, including magnetic media, optical media, random access memory (RAM), read-only memory (ROM), a data cache, a data object, etc. Moreover, memory 12 may reside at a single physical location, comprising one or more types of data storage, or be distributed across a plurality of physical systems in various forms.

Operating system 17 is shown stored in memory 12. Operating system 17 executes on CPU 16 and controls operation of public system 10. While shown stored in memory 12, other implementations of operating system 17 are possible. For example, operating system 17 can be implemented as hardware or stored in memory that is part of CPU 16.

I/O interfaces 14 may comprise any system for exchanging information from an external source. Bus 20 provides a communication link between each of the components in public system 10 and likewise may comprise any known type of transmission link, including electrical, optical, wireless, etc. In addition, although not shown, additional components, such as cache memory, communication systems, system software, etc., may be incorporated into public system 10.

Although not shown, each private system 24 may also comprise a CPU 16, I/O interfaces 14, memory 12 and bus 20. Alternatively, private systems 24 may be terminals in communication with public system 10. Moreover, each private system 24 may also include an operating system 17. Under the present invention, the private systems 24 and public system 10 can use different operating systems 17 and/or different versions of the same family of operating systems. Examples of operating systems include Windows(, Unix, Linux®, Mac OS X® or Solaris®. Public display 18 and private displays 26 can be a computer monitor, projection screen, flat panel (LCD) display, television screen, etc. on which users 23 can view information. Super-public display 22 can be any display on which multiple groups of users, as discussed in further detail below, can view information.

Cooperation system 28 allows each user 23 to individually control public system 10 while using private system 24 (as described in more detail below.) Cooperation system 28 can be implemented using software stored in memory 12, hardware, or a combination of software and hardware. It should be appreciated that although cooperation system 28 is shown stored in memory 12 of public system 10, cooperation system 28 and modules thereof may be located on each private system 24 and/or public system 10.

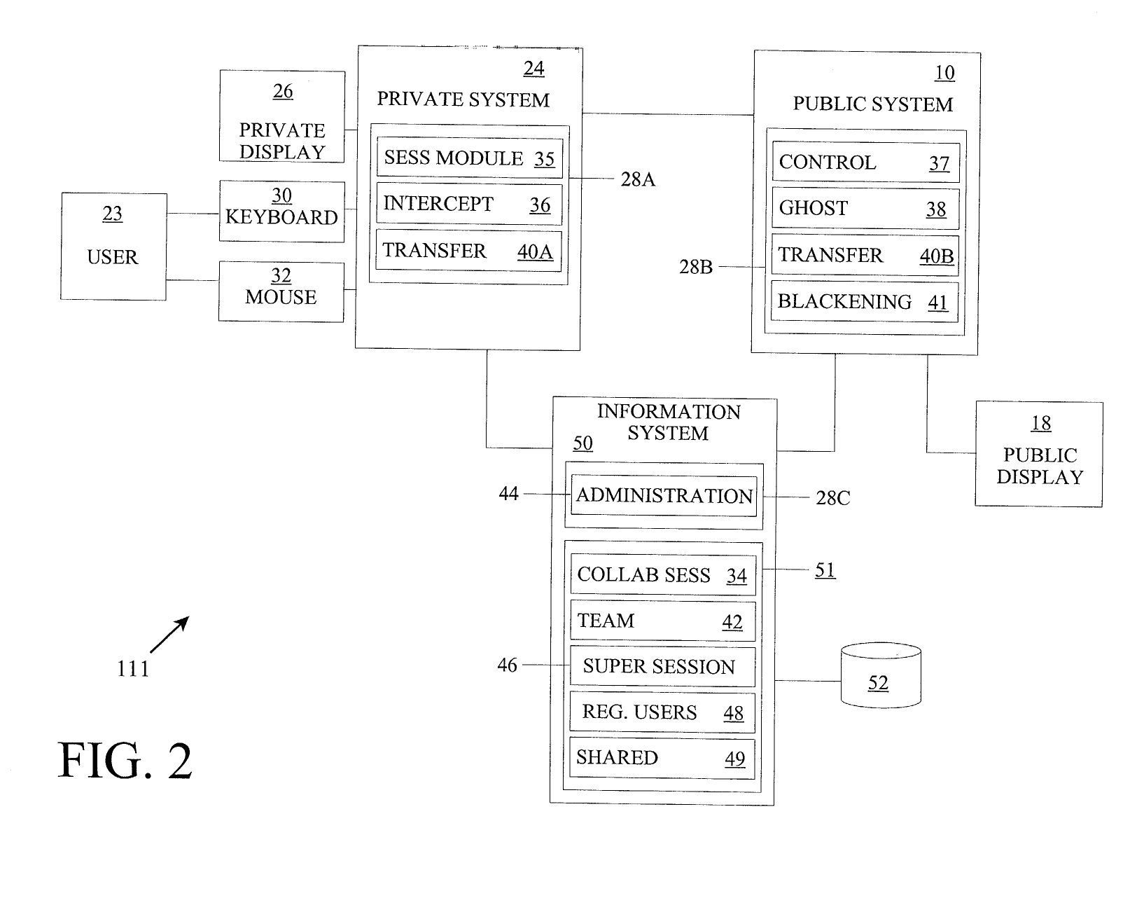

FIG. 2 depicts a more detailed view of a portion of collaboration system 111 according to one embodiment of the invention. As indicated above, collaboration system 111 includes a plurality of private systems 24 (only one of which is shown for clarity purposes) public system 10 and cooperation system 28A-C. For this embodiment, collaboration system 111 also includes information system 50 with data 51. Each private system 24 is in communication with public system 10, user 23, devices 26, 30, 32 and information system 50. Public system 10 is also in communication with information system 50 and public display 18. User 23 manipulates and views, for example, private display 26, keyboard 30 and mouse 32 to operate private system 24 and control public system 10 via cooperation system 28A-C. Furthermore, user 23 can be situated so that public display 18 is simultaneously visible with private display 26.

FIG. 2 shows various modules of cooperation system 28A-C and data 51 implemented on private system 24, public system 10 and information system 50. It is understood that all or some portion of each of these modules and data can be implemented on any one of the systems. FIG. 2 is presented in this manner for clarity, and is not intended to be limiting in any manner. Moreover, other modules and data may be used to implement certain aspects of the invention.

Cooperation system 28A-C is shown with modules present on each of the systems shown. Cooperation system 28A on private system 24 is shown with session module 35, intercept module 36 and transfer module 40A. In this embodiment, all private systems 24 contain a functionally equivalent portion of cooperation system 28A. Cooperation system 28B on public system 10 is shown with control module 37, ghost module 38, transfer module 40B and blackening module 41. Finally, cooperation system 28C on information system 50 is shown with administration module 44. Various embodiments of cooperation system 28A-C can include some or all of the modules shown. Additionally, other modules not shown can also be included in cooperation system 28A-C.

When desired, user 23 can use control module 37 to obtain control of public system 10. Control module 37 ensures that only one user 23 controls public system 10 at a time. When user 23 is controlling public system 10, intercept module 36 communicates an I/O command generated by an I/O device attached to private system 24 to control module 37. User 23 can generate such a command by using an I/O device (e.g., keyboard 30 and mouse 32) attached to private system 24. Although not shown, other I/O devices can also be used, for example, a trackball, a touchpad, voice command systems, etc. Control module 37 interprets the received I/O command as if it came from a similar I/O device attached to public system 10. Thus, for example, when user 23 moves mouse 32 attached to private system 24, a pointer displayed on public display 18 is moved accordingly. User 23 controls public system 10 in this manner until user 23 relinquishes control of public system 10.

Another user may desire control of public system 10 while user 23 is in control. In one embodiment, user 23 loses control when the other user gains control of public system 10. Other embodiments can use different methods, such as requiring user 23 in control of public system 10 to first relinquish control. Control module 37 can also provide users 23 with the capability to designate an order of control and/or a coordinator from whom control can not be taken without permission.

When user 23 is controlling public system 10, cooperation system 28A-C may allow user 23 to perform additional tasks beyond controlling public system 10. For example, user 23 may use blackening module 41 to “blacken” private displays 26 of each private system 24 that is sharing public system 10. Specifically, blackening module 41 can communicate with each private system 24 to blacken their respective private displays 26 so that attention can be focused on public display 18 or a particular user 23.

When one or more users 23 are not in control of public system 10, ghost module 38 of cooperation system 28B allows users 23 to “ghost” public system 10. Ghosting allows user(s) 23 to move an inert pointer on public display 18 to highlight portions thereof. For example, if user A has control of public system 10 and user B wishes to highlight a particular paragraph in a document, user B can activate ghost module 38. This allows user B to affect public display 18 without gaining control of public system 10. User B can use, for example, mouse 32 connected to private system 24 to point out or highlight the desired feature on public display 18. However, user 23 cannot perform any operations on public system 10. Commands attempting to control public system 10 while user 23 is ghosting can be ignored or discarded by intercept module 36, ignored or discarded by ghost module 38, generate an error from either intercept module 36 or ghost module 38 or can be accepted and acted upon by public system 10.

Transfer modules 40A-B allow user 23 to transfer data between systems. As depicted, transfer modules 40A, 40B are installed on both private system 24 and public system 10. User 23 can use transfer module 40A to, for example, copy a file from private system 24 to public system 10. To effect such a transfer, transfer module 40A communicates with transfer module 40B. Similarly, user 23 can use transfer module 40A to request a data transfer from public system 10 to private system 24, or to each private system 24 sharing control of public system 10. This ability eases the burden of maintaining up to date data on each private system 24.

As further described below, information system 50 can authorize or deny user 23 access to collaboration system 111. Additionally, access to and the permission to change data 51 on information system 50 can be regulated by a set of user privileges stored on information system 50. It is understood that although not shown, all functions and data 51 shown on information system 50 can be included in, for example, public system 10.

Some or all of data 51 on information system 50 may be stored in database 52. Database 52 may comprise one or more storage devices, such as a magnetic disk drive or an optical disk drive. In another embodiment, database 52 includes data distributed across, for example, a local area network (LAN), wide area network (WAN) or a storage area network (SAN) (not shown). Database 52 may also be configured in such a way that one of ordinary skill in the art may interpret it to include multiple databases.

Data 51 stored on information system 50 can be updated using administration module 44. As previously indicated, access to some or all of data 51 can be restricted. Collaboration system 111 can define certain users that have administrative privileges, whereby only users with the appropriate privileges can use administration module 44 to update data 51. This reduces the possibility of corruption of or unauthorized access to data 51.

Administration module 44 can establish and maintain a database of registered users 48 of collaboration system 111. For example, in a particular embodiment user 23 can log on to private system 24 by supplying a user name and password. Private system 24 can communicate with administration module 44 to check the user name and password against database of registered users 48 before allowing access to collaboration system 111. Once user 23 is confirmed as a registered user, user 23 can use private system 24 in an ordinary manner.

Administration module 44 can also allow a guest user to use collaboration system 111 who may be given limited privileges as discussed below.

Under the present invention, user 23 can be required to create a collaboration session 34 to engage in collaboration using private system 24 and public system 10. Thus, once user 23 has gained access to private system 24, he/she can use session module 35 to create such a session. In a typical embodiment, session module 35 communicates with administration module 44 to determine if user 23 has “permission” to create collaboration session 34 with public system 10. Administration module 44 may then communicate with control module 37 to determine if public system 10 is available. Once confirmed, collaboration session 34 can be created. Collaboration session 34 can be limited to specific users allowed to control public system 10. For example, control module 37 can prevent user 23 from controlling public system 10 without joining collaboration session 34.

Once created, other users can use session module 35 to join collaboration session 34. For example, session module 35 can communicate a request to join collaboration session 34 to administration module 44. Administration module 44 may compare the requesting user with database of registered users 48 to determine if he/she has permission to join collaboration session 34. In another embodiment, any user, including a guest user may be allowed to join collaboration session 34.

Administration module 44 can also establish and maintain a “team” 42 of registered users 48 that is included in collaboration session 34. Specifically, a user 23 seeking to create collaboration session 34, may be required to specify team 42 and/or belong to team 42 of registered users to successfully create collaboration session 34. Other users 23 belonging to team 42 could be allowed to join collaboration session 34. Conversely, users 23 not belonging to team 42, including registered users and guest users, can be allowed to join collaboration session 34 as a guest user, or not at all. A guest user may be given full privileges, or the privileges can be limited. These variations are within the scope of the present invention.

The use of team(s) 42 allows shared data 49 to be created on public system 10, private systems 24 and/or information system 50. Shared data 49 provides team 42 a common area to read and write data that persists after collaboration session 34 ends, thus allowing team 42 to continue collaboration over multiple collaboration sessions 34. Similarly, team 42 can use the same private systems 24, public system 10 and information system 50 as another team without corrupting shared data 49 of the other team. Access to shared data 49 can be regulated by administration module 44, which can ensure that user 23 belongs to team 42 and has the necessary privileges. Transfer module 40 can also communicate with administration module 44 to read and write to shared data 49 in similar fashion to the discussion above.

Private system 24 can display information regarding collaboration session 34 on private display 26. When a change occurs to collaboration session 34, for example, a new user joins collaboration session 34, administration module 44 can communicate the change to each private system 24 (i.e., that belong to collaboration session 34) in real time. Information displayed can include users joined to collaboration session 34, their private systems 24, the user controlling public system 10, users belonging to team 42, information on each user 23, etc. User 23 can be allowed to customize the display of this information by setting certain preferences. User 23 can also be allowed to edit some or all of this information. In this case, the modified information can be communicated to administration module 44 and updated appropriately. The amount of functionality allowed can be limited by user's 23 identity and permission established when user 23 logs on to private system 24.

Although not shown, collaboration system 111 can also include a plurality of public systems 10. In this case, a plurality of collaboration sessions 34, each with a different public system 10, can be active simultaneously. Session module 35 can further allow user 23 to create super session 46. This capability may be available only when user 23 is controlling public system 10. Super session 46 includes a plurality of collaboration sessions 34 and can include another “super” public system 10. Super session 46 allows users of a plurality of collaboration sessions 34 to combine and work together. For example, a project may have multiple parts, these parts can be split up among multiple teams of users, each team joined to a separate collaboration session working on different parts. When some or all teams of users want to combine parts and work on the project as a whole, super session 46 can be created.

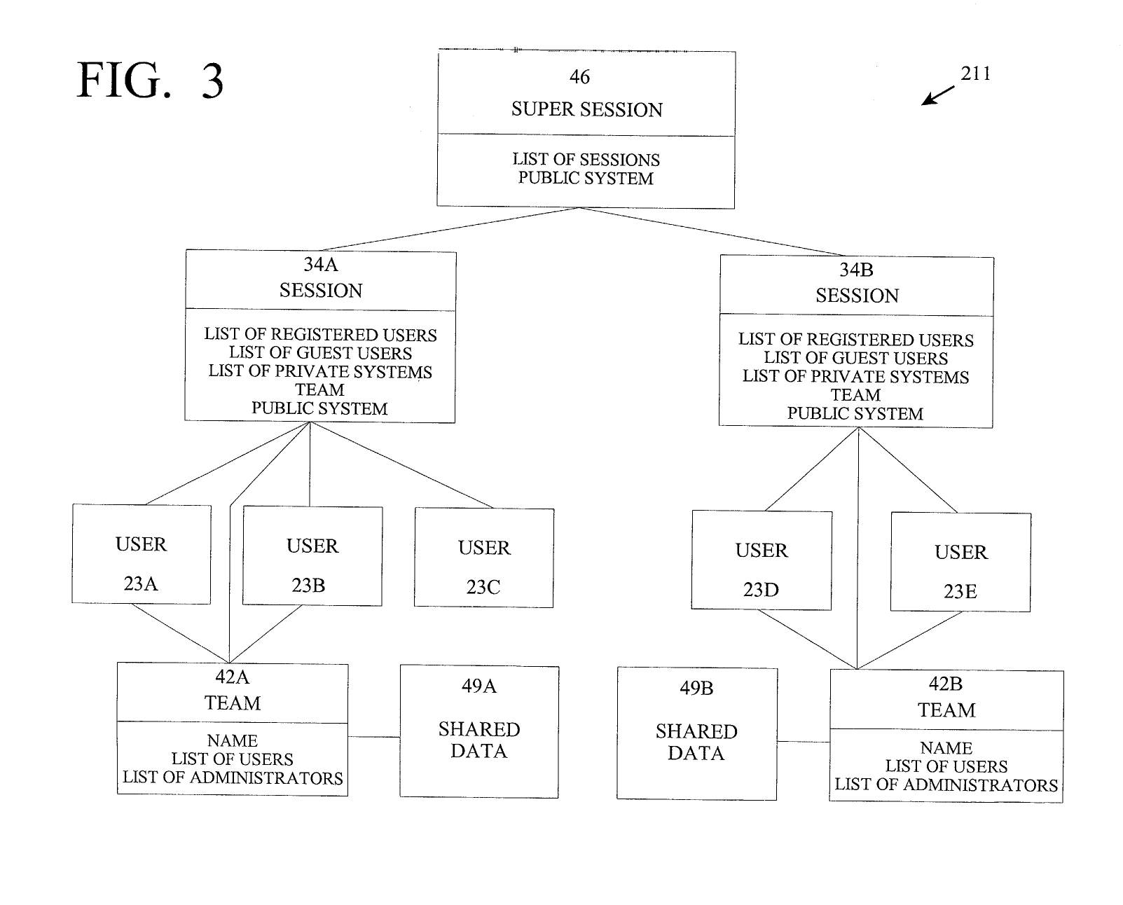

FIG. 3 shows a detailed view of multiple teams and sessions according to one embodiment of the invention. Users 23A-E are shown. Users 23A, 23B belong to team 42A and are joined to collaboration session 34A. Similarly, users 23D, 23E belong to team 42B and are joined to collaboration session 34B. User 23C does not belong to either team 42A or 42B, but is joined to collaboration session 34A as a guest user. Shared data 49A, 49B are associated with teams 42A, 42B, respectively. Super session 46 is shown as including collaboration sessions 34A, 34B.

Initially, users 23A, 23B, 23D, 23E are created, for example, as registered users 48 shown in FIG. 2. User 23C can be either a registered user 48 or a “guest.” While not shown joined to a team, user 23C can be a registered user 48 joined to a team other than team 42A. User 23A can create team 42A that is composed of a plurality of users, including users 23A, 23B. Team 42A can include a team name and one or more designated team administrators who may alter team membership and identity. Use of a team name simplifies the process for users to identify the desired team. Limiting users with administrative power, improves the integrity of the team data. Team 42A may be all users 23 assigned to a particular project or segment of a project.

In one embodiment, team 42A is required to start collaboration session 34A. In another embodiment, any user (e.g., 23A) can start collaboration session 34A and another user (e.g., 23B) can join. In either scenario, collaboration session 34A is an active collaboration among the joined users 23 (e.g., 23A-C). As shown, collaboration session 34A includes three private systems and a public system. Each user 23A-C operates a separate private system.

Users 23A-B of team 42A and user 23C can also share data with each other. Shared data 49A can be, for example, an area of disk space where users 23A-C can read and write data. Moreover, as indicated above, guest user 23C, can be given limited privileges, such as the ability to read but not write to shared data 49A.

When users 23A-E of collaboration sessions 34A, 34B desire to combine and collaborate together, super session 46 can be created. Super session 46 includes one or more simultaneously active collaboration sessions 34A, 34B. Super session 46 can have a “super” public system associated with it that is different from the public system(s) associated with the included collaboration sessions 34A, 34B. Super session 46 enables a plurality of collaboration sessions 34A, 34B to combine to merge, compare or discuss the work performed by collaboration sessions 34A, 34B individually.

As shown in FIG. 1, super-public display 22 can be used for super session 46. For example, a collaboration system may be implemented in a classroom of ten groups of five people collaborating on one common project. A number of collaboration sessions 34 may be active in the collaboration system. For example, ten collaboration sessions 34 each having a team 42 of five users 23 could exist. Each user would have his/her own private system 24 while each collaboration session 34 would include a public system 10. The members of each team 42 can collaborate using their respective private systems 24 and public system 10. However, all ten teams can collaborate collectively using super session 46 associated with super-public display 22. It should be appreciated that super-public display 22 can be part of public system 10, as shown, or part of a “super” public system (not shown). In the case of the latter, an instructor, for example, may administrate the “super” public system. Furthermore, collaboration sessions 34 participating in super session 46 can be in remote physical locations with a replication of super-public display 22 available at the remote location.

It is understood that the invention can be realized in hardware, software, or a combination of hardware and software. As indicated above, public systems according to the invention can be realized in a centralized fashion in a single computerized workstation, or in a distributed fashion where different elements are spread across several interconnected computer systems (e.g., a network). Any kind of computer system—or other apparatus adapted for carrying out the methods described herein—is suited. A combination of hardware and software can be a general purpose computer system with a computer program that, when loaded and executed, controls a public system such that it carries out the methods described herein. Alternatively, a specific use computer, containing specialized hardware for carrying out one or more of the functional tasks of the invention can be utilized.

The invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material document.

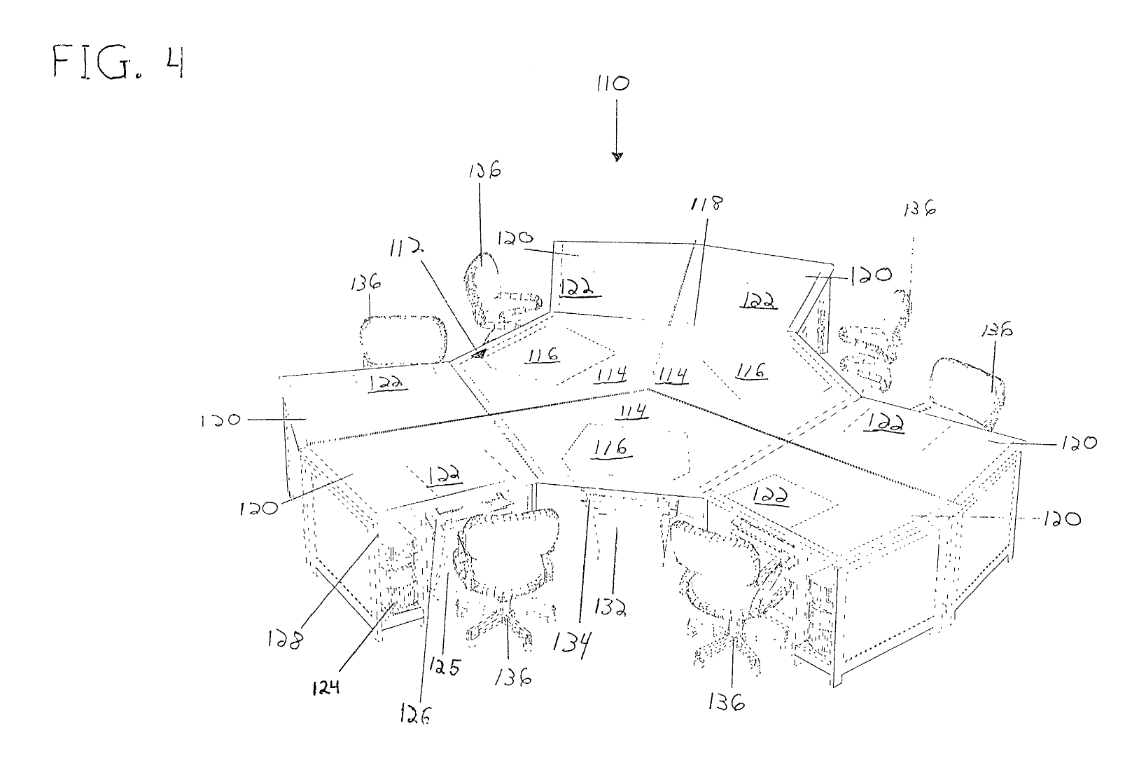

As indicated above, collaboration system 11 can be configured around a workstation configured to hold a plurality of private displays and at least one public display. The workstation can provide each user a view of a public display and a private display from a single location, a line of communication with every other user and a line of control to the public system. Referring now to FIG. 4, a perspective view of a workstation 110 according to one embodiment of the invention is depicted. As shown, workstation 110 includes a public section 112 and a plurality of private sections 120. Public section 112 can include one or more public segment(s) 114. Although not necessary to the invention, the use of a plurality of public segments 114 and private sections 120 provides modularity to workstation 110 for easy set-up and moving as well as some degree of physical separation among users. It is understood that the quantity of public segments 114 and private sections 120 may vary.

In one embodiment, public section 112 includes three public segments 114 and six sides 118. Three of sides 118 are each adjacent to two private sections 120. As shown in FIG. 4, two private sections 120 adjacent to the same side 118 can also be adjacent to each other. Similarly, each public segment 114, as a unit, can be adjacent to a plurality of private sections 120 that are distally positioned with respect to one another.

Each public segment 114 is configured to hold a public display. As shown in FIG. 4, positioned in a top surface of each public segment 114 can be one or more public window(s) 116. Public windows 116 are clear panes through which users (not shown) can view a public display 134 such as a computer monitor (shown in FIG. 1 as public display 18). Public support mechanisms 132 can be provided under the top surface of each public segment 114 to support public display 134. Public support mechanisms 132 can be adjustable so that users can place public displays 134 at various angles and/or positions. Public system 10 (shown in FIGS. 1 & 2) can be positioned proximate public section 112 or in a remote location. If public system 10 is remotely located, private systems 124 (24 in FIG. 1) can be connected to public system 10 as described above. In particular, connectivity can be achieved via remote workstations in a client-server environment.

Each private section 120 is configured to hold a private display 126. For example, private windows 122 can be positioned in a top surface of each private section 120 through which users can view private displays 126. Private sections 120 also can include a storage compartment 128 for storing private system 124, as well as private support mechanism 125 for supporting private display 126. Similar to public support mechanism 132, private support mechanisms 124 can be adjustable to allow users to place private displays 126 at various angles and/or positions. Alternatively, private system 124 can be a laptop or other computer system placed on top of private section 120 with a built-in display, keyboard and pointing device.

Public windows 116 and private windows 122 can be constructed from a transparent material (e.g., glass, plexi-glass, polycarbonate, etc.) so that private displays 126 and public displays 134 can be viewed therethrough. Each display can be for example, a CRT monitor, flat screen panel (e.g., LCD), television monitor, etc. and can be incorporated directly into workstation 110.

It is understood that the configuration of workstation 110 can vary depending on the needs of the users. For example, support mechanisms 125 and can be attached to workstation 110 or can be freestanding units positioned under the top surface thereof.

The configuration of workstation 110 allows users seated in or around chairs 136 to view at least one private display 126 as well as a public display 134 from a single location. Using the invention, a group of users can collaborate, for example, on a project, using public display 134 while working on individual components of the project using private displays 126. As indicated above, users can collaborate by using the I/O devices of their private system 124 to control the public system.

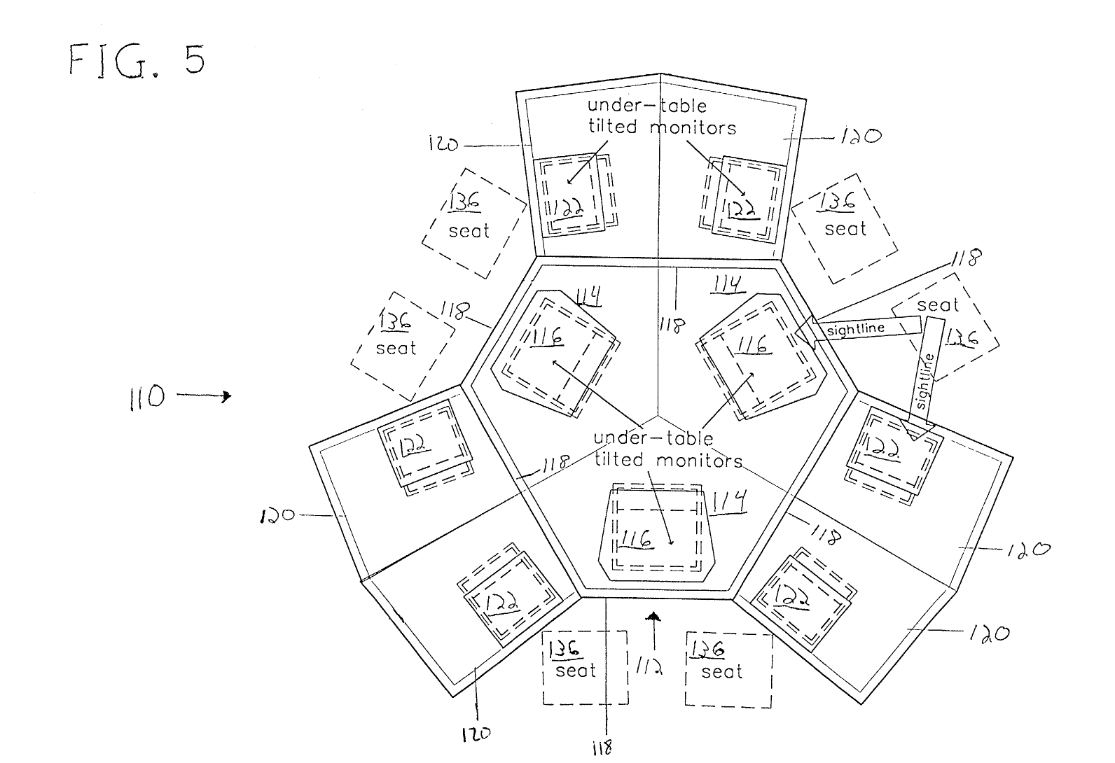

FIG. 5 depicts a top view of workstation 110 according to one embodiment of the invention. As depicted, public section 112 includes three public segments 114 adjacent to each other, which collectively form a six-sided 118 public section 112. Positioned about three of sides 118 are two private sections 120 also adjacent to each other. A user positioned in a seat 136 can see at least one public window 116 as well as at least one private window 122. This configuration allows each user to view and communicate with every other user with little or no movement. Specifically, users can sit in seats 136 and face in an inward direction that allows them to see each other. No user has to rotate more than 90° to see any other user at workstation 110. Accordingly, workstation 110 effectively allows a plurality of users to collaborate on a project.

As depicted and described herein, the general configuration of workstation 110 includes a public section 112 as a hub section and a plurality of private sections 120 creating spoke sections around the hub section. While FIGS. 4 & 5 depict workstation 110 as having three spoke sections and accommodating six users, it is understood that any number of spoke sections can be utilized to accommodate more or less than six users. Additionally, while the discussion provides for a single public system 10 connected to a plurality of public displays 134, it is understood that multiple public systems 10 can be implemented with this design. For example, each group of two users distally positioned adjacent to a public segment 114, can share their own public system.

The foregoing description of the various embodiments of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A collaboration system and workstation for a plurality of users, comprising:
a public system;
a plurality of private systems, wherein each user operates their own private system;
a cooperation system for a user of a private system to control the public system; and
a workstation including:
a public section including at least one public segment, wherein each public segment is configured to hold a public display for the public system; and
its a plurality of private sections positioned around the public section, wherein each private section is configured to hold a private display for a private system.

2. The system and workstation of claim 1, wherein the public system has at least one public display and each private system has a private display.

3. The system and workstation of claim 2, wherein each user can view a private display for their private system and a public display from a single location.

4. The system and workstation of claim 1, wherein the plurality of private systems and the public system use a plurality of operating systems.

5. The system and workstation of claim 1, wherein each public segment includes at least one public window for a user to view a public display through a public window.

6. The system and workstation of claim 1, wherein each private section includes a private window for a user to view a private display.

7. The system and workstation of claim 1, wherein each private section holds a private system, and wherein a user can control the public system from any private section using an I/O device of a private system.

8. The system and workstation of claim 7, wherein the I/O device is selected from the group consisting of a mouse and a keyboard.

9. The system and workstation of claim 1, further comprising at least one super public display, in communication with a public system, for allowing all users to view output from the public system, wherein each user can view a super-public display and a private display for their private system from a single location.

10. A collaboration system and workstation for allowing collaboration among a plurality of users, comprising:
a collaboration system for a user of a private system to control a public system from the private system, wherein each private system has a private display and the public system has at least one public display;
a public section including at least one public segment, wherein each public segment is configured to hold a public display; and
a plurality of private sections each positioned adjacent to the public section, wherein each private section is configured to hold a private display.

11. The collaboration system and workstation of claim 10, wherein each public segment includes a window for viewing the public display.

12. The collaboration system and workstation of claim 10, wherein each private section includes a window for viewing the private display.

13. The collaboration system and workstation of claim 10, wherein each public segment is adjacent to a plurality of distally positioned private sections.

14. The collaboration system and workstation of claim 13, wherein each public segment is further adjacent to at least one other public segment.

15. The collaboration system and workstation of claim 10, wherein the collaboration system further comprises:
a control module for obtaining control of the public system and relinquishing control of the public system;
a ghost module for ghosting the public system;
a blackening module for controlling the public system to blacken each private display; and
an administration module for establishing and maintaining a database of teams of users.

16. A workstation for allowing collaboration among a plurality of users, comprising:
a public section including at least one public segment, wherein each public segment is configured to hold a public display for a public system; and
a plurality of private sections positioned around the public section, wherein each private section is configured to hold a private display for a private system.

17. The workstation of claim 16, wherein each public segment includes a window for viewing the public display.

18. The workstation of claim 16, wherein each private section includes a window for viewing the private display.

19. The workstation of claim 16, wherein each public segment is adjacent to a plurality of distally positioned private sections.

20. The workstation of claim 19, wherein each public segment is further adjacent to at least one other public segment.
